(19) United States
(12) Patent Application Publication
(10) Pub. No.: US 2024/0228710 A1
(43) Pub. Date: Jul. 11, 2024

(54) Polymer Articles For A Coolant Fluid Circuit in Electric Vehicles

(71) Applicant: Celanese International Corporation, Irving, TX (US)

(72) Inventors: Sabine Steinbach, Kelkheim (DE); Kirsten Markgraf, Weinheim (DE)

(21) Appl. No.: 18/406,604

(22) Filed: Jan. 8, 2024

Related U.S. Application Data
(60) Provisional application No. 63/438,131, filed on Jan. 10, 2023.

(51) Int. Cl. C08J 5/04; C08K 5/24; C08K 5/315; C08K 9/06

(52) U.S. Cl. CPC C08J 5/043; C08K 5/24; C08K 5/315; C08K 9/06; C08J 2359/02

(57) ABSTRACT

Molded polymer components are described that are configured to be used in a coolant fluid circulation system. The molded polymer components, for instance, can at least partially define a coolant fluid pathway and are well suited for use in cooling batteries and other electrical components in electric vehicles. The molded polymer components can be made from a polyoxymethylene polymer composition containing reinforcing fibers.

### RELATED APPLICATIONS

The present application is based upon and claims priority to U.S. Provisional Patent Application Ser. No. 63/438,131, having a filing date of Jan. 10, 2023, which is incorporated herein by reference.

### BACKGROUND

Electric vehicles that employ electric power for all or a portion of their motive power (e.g., electric vehicles, hybrid electric vehicles, and plug-in hybrid electric vehicles) can provide a number of advantages to more traditional gas-powered vehicles. For example, electric vehicles may produce fewer undesirable emission products and may exhibit greater fuel efficiency as compared to vehicles using internal combustion engines. As electric vehicle technology continues to evolve, there is a need to provide improved battery systems for such vehicles to increase the distance that such vehicles may travel without the need to recharge.

In this regard, manufacturers have begun to develop lithium-ion batteries that have a high charge density and can store a high level of charge. Unfortunately, lithium-ion batteries also tend to be sensitive to temperature and can thus experience failure when excessively high temperatures are reached. For example, batteries work based on the principle of a voltage differential and, at high temperatures, the electrons inside the batteries become excited which decreases the difference in voltage between the two sides of the battery. Consequently, for proper operation, the batteries need to be maintained within a particular temperature range, such as from about 18° C. to about 43° C. If large internal temperature differences occur in a battery pack or if the temperature is raised above a certain threshold, potential thermal stability issues may arise including capacity degradation, thermal runaway, or the like.

In view of the above, battery systems in electric vehicles need an effective coolant system. Various different methods and techniques have been proposed in the past in order to cool battery packs. For instance, in the past, the installation of cooling fins, air cooling, and liquid coolant systems have been proposed. Liquid coolant systems have higher heat conductivity and heat capacity. Consequently, liquid coolant systems have shown to be well suited for maintaining a battery pack within a correct temperature range.

Liquid coolant systems can include direct coolant systems and indirect coolant systems. In direct coolant systems, the battery cells are placed in direct contact with a coolant liquid. In indirect coolant systems, on the other hand, a coolant liquid is circulated through a series of pipes or tubes that indirectly cool the battery cells. In both systems, components are needed in order to circulate the coolant fluid. These components can include pumps, valves, manifolds, tubes, and the like.

In the past, many components contained in a coolant system were made from metals. Metals, however, can add weight to the vehicle. Thus, a need currently exists for coolant system component parts made from lighter materials, such as polymer materials. Coolant liquids, however, can cause various different polymers to degrade. In addition, various different polymers can swell and absorb coolant liquids which can also cause the physical properties of the polymer parts to decrease.

In view of the above, a need currently exists for components and parts configured to be installed in a coolant fluid circulation system that are made from non-metals. More particularly, a need exists for a polymer composition well suited to producing components and parts for a coolant liquid system that do not degrade or otherwise deteriorate when exposed to a coolant fluid and/or have physical properties making the polymeric components or parts well suited for use in a coolant fluid system environment for an electric vehicle.

### SUMMARY

In general, the present disclosure is directed to polymer articles well suited for being used as components and parts in a coolant fluid system or circuit. The polymer articles are formed from a polymer composition containing a polyoxymethylene polymer blended with reinforcing fibers. The polyoxymethylene polymer composition of the present disclosure has been found to have high resistance to coolant fluids with low heat aging.

In one aspect, the present disclosure is directed to a polymer article comprising a molded polymer component defining at least a portion of a fluid flow path. The molded polymer component is configured to be a portion of a coolant circuit for circulating a coolant fluid. For example, the coolant fluid can be a glycol, such as ethylene glycol or propylene glycol. The molded polymer component is formed from a polymer composition comprising a polyoxymethylene polymer blended with reinforcing fibers. The reinforcing fibers are present in the composition in an amount from about 5% to about 55% by weight.

Various different polymer articles can be formed in accordance with the present disclosure. The polymer article, for instance, can be a distribution manifold, a valve component, a housing defining at least one coolant fluid pathway, a radiator tank, such as a radiator expansion tank, a tube, a pump component, such as an impeller, or the like.

In one aspect, the polymer composition further contains a formaldehyde scavenger. The presence of a formaldehyde scavenger has been found to further increase the resistance of the polymer composition to any type of coolant fluid degradation. The formaldehyde scavenger can be a nitrogen-containing compound. In one aspect, the formaldehyde scavenger can comprise 1,3,5-triazine-2,4,6-triamine or a derivative thereof. The formaldehyde scavenger can be present in the polymer composition in an amount from about 0.01% to about 1% by weight, such as from about 0.05% to about 0.3% by weight.

In one embodiment, the polyoxymethylene polymer contained in the polymer composition includes reactive groups at terminal positions on the polymer. The polymer composition can further include a coupling agent that couples the polyoxymethylene polymer to the reinforcing fibers. For example, the reinforcing fibers can be coated with a sizing agent and the coupling agent can couple the reactive groups on the polyoxymethylene polymer to the sizing agent. The coupling agent, for instance, can comprise an isocyanate, such as an organic diisocyanate. The coupling agent can be present in the polymer composition in an amount from about 0.2% by weight to about 3% by weight.

The reactive groups on the polyoxymethylene polymer can comprise hydroxyl groups. For instance, in one aspect, at least 50% of all terminal groups present on the polyoxymethylene polymer comprise hydroxyl groups. In another aspect, the hydroxyl groups can be present on the polyoxymethylene polymer in an amount greater than about 5 mmol/kg, such as in an amount greater than about 10 mmol/kg, such as in an amount greater than about 15 mmol/kg, such as in an amount greater than about 20 mmol/kg, such as in an amount greater than about 25 mmol/kg, such as in an amount greater than about 30 mmol/kg, such as in an amount greater than about 35 mmol/kg, such as in an amount greater than about 40 mmol/kg, and generally in an amount less than about 100 mmol/kg.

The polyoxymethylene polymer can have a melt volume flow rate of from about 4 cm³/10 min to about 25 cm³/10 min, such as from about 6 cm³/10 min to about 15 cm³/10 min when measured at 190° C. and at a load of 2.16 kg.

In one particular embodiment, the polyoxymethylene polymer can be present in the polymer composition in an amount from about 50% to about 85% by weight. The reinforcing fibers can be present in the polymer composition in an amount from about 15% to about 30% by weight and can comprise glass fibers. Optionally, a coupling agent can be present in the polymer composition in an amount from about 0.1% to about 1.5% by weight.

The polymer composition of the present disclosure has been found well suited for contact with a coolant fluid. The polymer composition not only has excellent physical properties but can maintain those properties when in constant contact with a coolant fluid over a significant period of time. For example, the polymer composition of the present disclosure can be placed in a coolant fluid at 108° C. and various properties can be measured initially and after 1,008 hours. When tested according to a coolant fluid weight change test, for instance, the polymer composition may increase in weight in an amount less than about 4%, such as in an amount less than about 2%. When tested according to a coolant fluid thickness change test, the polymer composition may increase in thickness by less than about 3%, such as by less than about 2%, such as by less than about 1.2%, such as by less than about 1%. When tested according to a coolant fluid break stress change test, the break stress on the polymer composition may decrease by no more than about 60%, such as by no more than about 50%. When tested according to a coolant fluid tensile modulus change test, the tensile modulus of the polymer composition may decrease by no more than about 60%, such as by no more than about 40%. In addition, when tested according to a coolant fluid Charpy notched impact strength change test, the impact strength of the polymer composition may decrease by no more than about 50%, such as by no more than about 40%, such as by no more than about 30%.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of an electric vehicle that may incorporate parts or components made in accordance with the present disclosure;

FIG. 2 is a perspective view of one embodiment of a coolant fluid tube;

FIG. 3 is a side view of one embodiment of a manifold that may be made in accordance with the present disclosure;

FIG. 4 is a side view of one embodiment of a coolant fluid tank made in accordance with the present disclosure;

FIG. 5 is a side view of one embodiment of a coolant fluid valve that may include components or parts made in accordance with the present disclosure;

FIG. 6 is a graphical representation of some of the results obtained in the examples described below.

FIG. 7 is a graphical representation of some of the results obtained in the examples described below.

FIG. 8 is a graphical representation of some of the results obtained in the examples described below.

FIG. 9 is a graphical representation of some of the results obtained in the examples described below.

FIG. 10 is a graphical representation of some of the results obtained in the examples described below.

FIG. 11 is a graphical representation of some of the results obtained in the examples described below.

FIG. 12 is a graphical representation of some of the results obtained in the examples described below.

FIG. 13 is a graphical representation of some of the results obtained in the examples described below.

FIG. 14 is a graphical representation of some of the results obtained in the examples described below.

FIG. 15 is a graphical representation of some of the results obtained in the examples described below.

FIG. 16 is a graphical representation of some of the results obtained in the examples described below.

FIG. 17 is a graphical representation of some of the results obtained in the examples described below.

Repeat use of reference characters in the present specification and drawings is intended to represent the same or analogous features or elements of the present invention.

### Definitions

As used herein, all coolant fluid aging tests are performed on ISO test specimen 3167 Type A. The test specimen is placed in a coolant fluid at 108° C. for 1,008 hours. The coolant fluid contains 50% by weight GLYSANTIN G40 antifreeze (ethylene glycol containing salts of organic acids and silicates) commercially available from BASF and 50% distilled water. Prior to testing, each test specimen is pre-conditioned by being dried for 72 hours at 80° C. in a heating cabinet after molding. The test specimens can be measured for weight change (coolant fluid weight change test), thickness change (coolant fluid thickness change test), break stress (coolant fluid break stress change test), tensile modulus (coolant fluid tensile modulus change test), impact strength (coolant fluid Charpy notched impact strength change test) and any other tensile property.

As used herein, tensile properties are measured according to ISO Test 527-1,-2 using tensile test specimen 1A, injection molded, at a test speed of 5 mm/min.

As used herein, Charpy notched impact strength is determined according to ISO Test 179-1/1eA using test specimen ISO 3167 Type A.

For any standardized test methods described herein, unless otherwise denoted, the latest addition of the test procedure applies.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to polymer articles that can be used to construct a coolant fluid circuit. The polymer articles are intended to be in contact with the coolant fluid. For instance, the polymer articles can comprise molded polymer components that define at least a portion of a fluid flow path (e.g. come into contact with a coolant fluid when in use). In accordance with the present disclosure, the polymer articles are formed from a fiber reinforced polyoxymethylene polymer composition. It was discovered that fiber reinforced polyoxymethylene polymer compositions not only possess excellent physical properties but also display exceptional dimensional stability when placed in contact with coolant fluids at elevated temperatures for extended periods of time. The polyoxymethylene polymer compositions of the present disclosure, for instance, offer various advantages and benefits in comparison to the use of other polymers and/or in comparison to the use of metals.

The polymer composition of the present disclosure generally contains a polyoxymethylene polymer combined with reinforcing fibers, particularly glass fibers. Although unknown, it was discovered that incorporating a formaldehyde scavenger into the polymer composition can also dramatically improve dimensional stability when placed in contact with coolant fluids. Optionally, a coupling agent can also be incorporated into the polymer composition for coupling the polyoxymethylene polymer to the reinforcing fibers. The polyoxymethylene polymer, for instance, can be produced with reactive end groups that react with the coupling agent. The reinforcing fibers, on the other hand, can be coated with a sizing agent that also reacts with the coupling agent.

Polymer articles made according to the present disclosure are particularly well suited for constructing coolant fluid systems that are designed to be incorporated into electric vehicles. The coolant fluid system, for instance, can be used to cool battery packs in order to ensure that the battery cells are maintained within a preset and desired temperature range. The polymer composition of the present disclosure can be used to make any component in a coolant fluid system that comes into contact with the coolant fluid. The polymer composition also displays excellent tribological properties and can be used to produce parts that contact a coolant fluid and move between different positions such as a valve or manifold component.

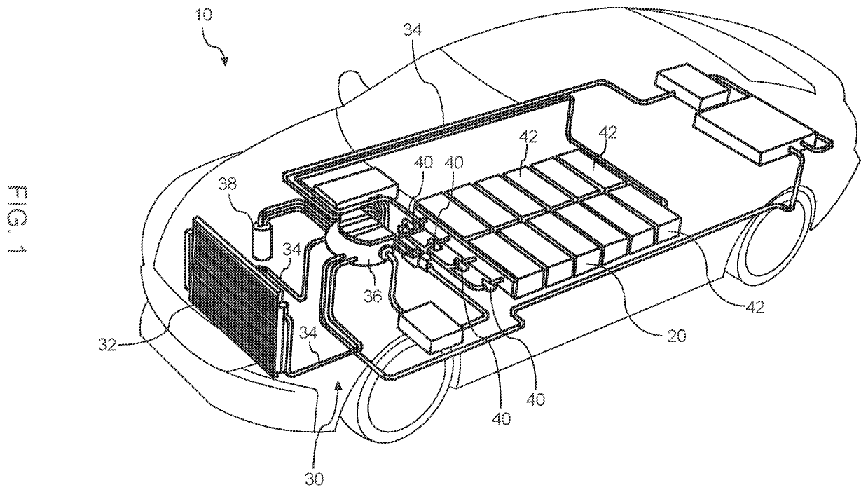

Referring to FIG. 1, one embodiment of an electric vehicle 10 is shown that illustrates a battery system 20 in communication with a coolant fluid system 30.

It should be understood that the battery system or module 20 can be employed in a wide variety of vehicles, such as an electric vehicle, a hybrid electric vehicle, a plug-in hybrid electric vehicle, or other type of vehicle using electric power for propulsion. The vehicle may be in the form of an automobile, bus, truck, motorcycle, boat, etc. In the embodiment illustrated in FIG. 1, for instance, the electric vehicle 10 is shown in the form of an automobile or car. The battery system 20 is for providing all or a portion of the motive power of the vehicle 10.

In FIG. 1, the battery system 20 is shown positioned in the center of the vehicle. The battery system 20, however, can be positioned in the trunk or rear of the vehicle or in any other suitable location. The position of the battery system 20 may be selected based on the availability of space within the vehicle, the desired weight balance of the vehicle, the location of the other components that are connected to the battery system, and a variety of other considerations.

In order to maintain the batteries contained within the battery system 20 within a preset temperature range and to prevent the batteries from overheating, the electric vehicle 10 includes the coolant fluid circulation system 30. The coolant fluid system 30 can include a radiator tank 32 that is connected to a plurality of fluid conveying tubes 34.

As shown in FIG. 1, the coolant system 30 can include a central module 36 that can contain one or more pumps, one or more valves, and one or more sliders for directing the coolant fluid around the circulation system 30. The central module 36, for instance, can be in fluid communication with an expansion or radiator tank 38 and with a plurality of temperature and/or pressure sensors 40.

As illustrated in FIG. 1, the battery system 20 can include individual battery packs that are each contained in a housing 42. Each of the housings 42 can be in communication with the coolant fluid circulation system 30 for circulating a coolant fluid through the housing 42. The coolant fluid, for instance, can directly cool each battery pack or can indirectly cool each battery pack.

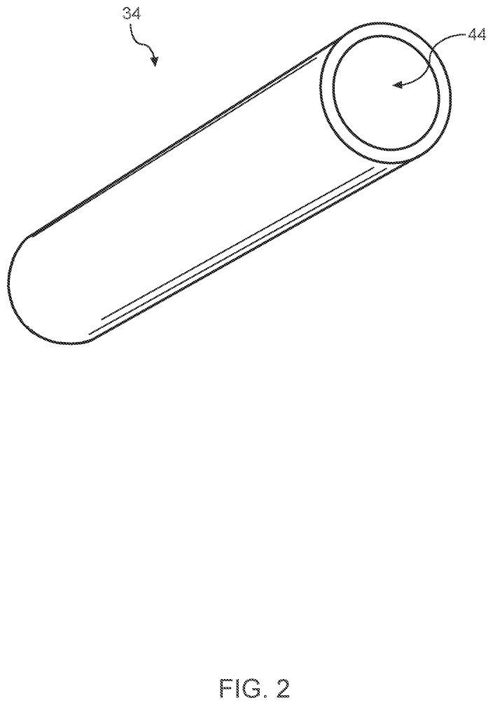

Molded polymer components made in accordance with the present disclosure are well suited for constructing any portion of the coolant fluid circulation system 30 as shown in FIG. 1. For example, referring to FIG. 2, a coolant fluid tube 34 is shown. The coolant fluid tube 34 defines a coolant fluid passage or flow path 44. The coolant fluid tube 34 can be made entirely from the polymer composition of the present disclosure comprising a polyoxymethylene polymer combined with reinforcing fibers.

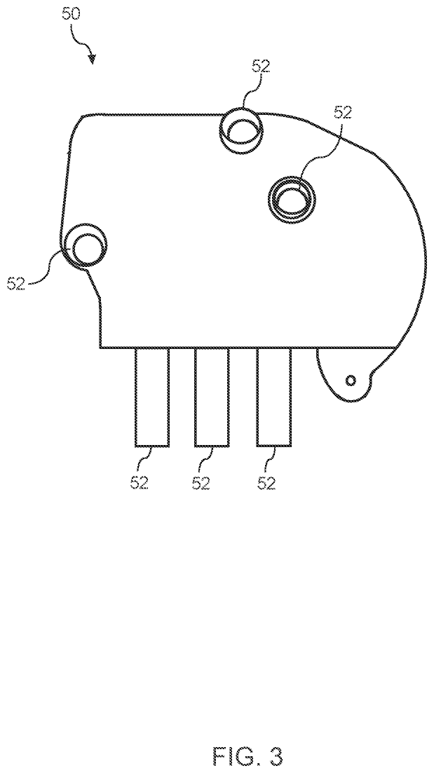

The polymer composition of the present disclosure can also be used to form a coolant fluid manifold 50 as shown in FIG. 3. The manifold 50 can be for connecting one tube with other tubes. For instance, the manifold 50 can include multiple inlets and outlets 52 and can be used to direct a coolant fluid to certain places within the coolant fluid system.

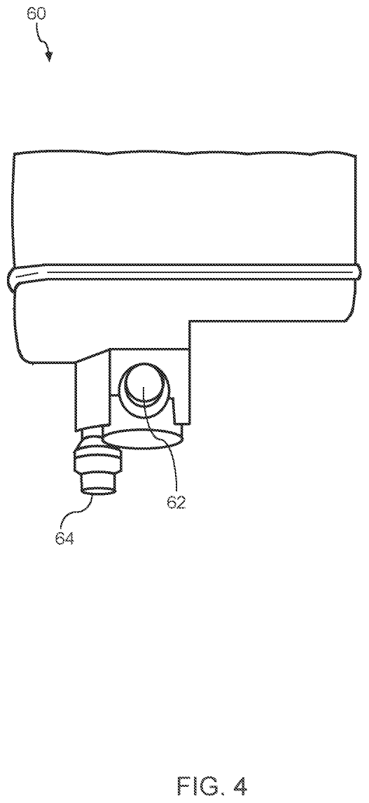

The polymer composition of the present disclosure can also be used to produce a coolant fluid tank 60 as shown in FIG. 4. The coolant fluid tank 60 can be a radiator tank or can be an expansion tank and can be in fluid communication with the coolant fluid circulation system. As shown in FIG. 4, the tank 60 can include a fluid inlet 62 and a fluid outlet 64 for receiving and releasing coolant fluids. In accordance with the present disclosure, the entire tank can be molded from the polyoxymethylene polymer composition.

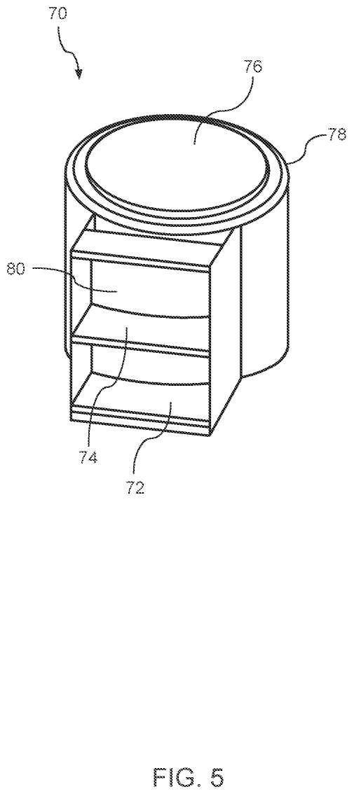

As described above, the coolant fluid system can include a plurality of valves that help direct coolant fluid based upon conditions within the system for maintaining the temperature of the battery packs within a preset temperature range. Referring to FIG. 5, one embodiment of a valve device 70 that can be used in the coolant fluid system is illustrated. The valve device 70 includes a fluid inlet 72 and a fluid outlet 74 that are in fluid communication with a valve component 76 that is contained within a housing 78. The polyoxymethylene polymer composition can be used to mold the inlet 72, the outlet 74, and the housing 78. The valve device 70 may also include various different movable slider parts 80 or components contained within the valve housing. The polyoxymethylene polymer composition is also well suited to producing all different types of movable parts that may also be in contact with the coolant fluid. The polyoxymethylene polymer composition of the present disclosure, for instance, has excellent tribological properties making the polymer composition well suited for producing movable parts.

As described above, the polymer articles of the present disclosure can comprise molded polymer components defining at least a portion of a fluid flow pathway for a coolant fluid. The articles are formed from a polyoxymethylene polymer composition containing reinforcing fibers, such as glass fibers. Optionally, the polymer composition can also contain one or more formaldehyde scavengers that have been found to further improve the thermal aging properties of the polymer when exposed to coolant fluids, such as propylene glycol. Generally, coolant fluids contain ethylene glycol or propylene glycol, water, and various additives. Additives that can be contained in the coolant fluid include phosphates, silicates, organic acids, inorganic additives, nitrites, amines, or combinations thereof. The polymer composition of the present disclosure is chemically resistant to the coolant fluids and the various additives described above. In this manner, the polymer composition is dimensionally stable when molded into a polymer article and maintains tensile strength, impact resistance, and the like even when exposed to coolant fluids over a long period of time at elevated temperatures. It was discovered that the inclusion of reinforcing fibers, particularly glass fibers, dramatically improves dimensional stability.

The polymer composition of the present disclosure contains a polyoxymethylene polymer. The preparation of the polyoxymethylene polymer can be carried out by polymerization of polyoxymethylene-forming monomers, such as trioxane or a mixture of trioxane and a cyclic acetal such as dioxolane in the presence of a molecular weight regulator, such as a glycol. The polyoxymethylene polymer used in the polymer composition may comprise a homopolymer or a copolymer. According to one embodiment, the polyoxymethylene is a homo- or copolymer which comprises at least 50 mol. %, such as at least 75 mol. %, such as at least 90 mol. % and such as even at least 97 mol. % of —CH₂O-repeat units.

In one embodiment, a polyoxymethylene copolymer is used. The copolymer can contain from about 0.1 mol. % to about 20 mol. % and in particular from about 0.5 mol. % to about 10 mol. % of repeat units that comprise a saturated or ethylenically unsaturated alkylene group having at least 2 carbon atoms, or a cycloalkylene group, which has sulfur atoms or oxygen atoms in the chain and may include one or more substituents selected from the group consisting of alkyl cycloalkyl, aryl, aralkyl, heteroaryl, halogen or alkoxy. In one embodiment, a cyclic ether or acetal is used that can be introduced into the copolymer via a ring-opening reaction.

Preferred cyclic ethers or acetals are those of the formula:

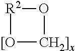

in which x is 0 or 1 and R² is a C₂-C₄-alkylene group which, if appropriate, has one or more substituents which are C₁-C₄-akyl groups, or are C₁-C₄-alkoxy groups, and/or are halogen atoms, preferably chlorine atoms. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also of linear oligo- or polyformals, such as polydioxolane or polydioxepan, as comonomers. It is particularly advantageous to use copolymers composed of from 99.5 to 95 mol. % of trioxane and of from 0.5 to 5 mol. %, such as from 0.5 to 4 mol. %, of one of the above-mentioned comonomers.

The polymerization can be effected as precipitation polymerization or in the melt. By a suitable choice of the polymerization parameters, such as duration of polymerization or amount of molecular weight regulator, the molecular weight and hence the MVR value of the resulting polymer can be adjusted.

In one embodiment, the polyoxymethylene polymer used in the polymer composition may contain a relatively high amount of reactive groups or functional groups in the terminal position. The reactive groups or functional groups can comprise any groups that are capable of forming a bond with a coupling agent. The reactive groups, for instance, may comprise —OH or —NH₂ groups.

In one embodiment, the polyoxymethylene polymer can have terminal hydroxyl groups, for example hydroxyethylene groups and/or hydroxyl side groups, in at least more than about 50% of all the terminal sites on the polymer. For instance, the polyoxymethylene polymer may have at least about 70%, such as at least about 80%, such as at least about 85% of its terminal groups be hydroxyl groups, based on the total number of terminal groups present. It should be understood that the total number of terminal groups present includes all side terminal groups.

In one embodiment, the polyoxymethylene polymer has a content of terminal hydroxyl groups of at least 5 mmol/kg, such as at least 10 mmol/kg, such as at least 15 mmol/kg, such as at least 18 mmol/kg, such as at least 20 mmol/kg, such as at least 25 mmol/kg, such as at least 30 mmol/kg, such as at least 35 mmol/kg, such as at least 40 mmol/kg, such as at least 45 mmol/kg, such as at least 50 mmol/kg, such as at least 55 mmol/kg, such as at least 60 mmol/kg, such as at least 65 mmol/kg, such as at least 70 mmol/kg. In one embodiment, the terminal hydroxyl group content ranges from 18 to 100 mmol/kg. In an alternative embodiment, the polyoxymethylene polymer may contain terminal hydroxyl groups in an amount less than 20 mmol/kg, such as less than 18 mmol/kg, such as less than 15 mmol/kg, such as less than 10 mmol/kg, such as less than 5 mmol/kg. For instance, the polyoxymethylene polymer may contain terminal hydroxyl groups in an amount from about 5 mmol/kg to about 20 mmol/kg, such as from about 5 mmol/kg to about 15 mmol/kg.

In addition to the terminal hydroxyl groups, the polyoxymethylene polymer may also have other terminal groups usual for these polymers. Examples of these are alkoxy groups, formate groups, acetate groups or aldehyde groups. In one aspect, the polyoxymethylene polymer is free of silane or groups containing silicon. According to one embodiment, the polyoxymethylene is a homo- or copolymer which comprises at least 50 mol-%, such as at least 75 mol-%, such as at least 90 mol-% and such as even at least 95 mol-% of —CH₂O-repeat units.

In one embodiment, a polyoxymethylene polymer with hydroxyl terminal groups can be produced using a cationic polymerization process followed by solution hydrolysis to remove any unstable end groups. During cationic polymerization, a glycol, such as ethylene glycol can be used as a chain terminating agent. The cationic polymerization results in a bimodal molecular weight distribution containing low molecular weight constituents. In one particular embodiment, the low molecular weight constituents can be significantly reduced by conducting the polymerization using a heteropoly acid such as phosphotungstic acid as the catalyst. When using a heteropoly acid as the catalyst, for instance, the amount of low molecular weight constituents can be less than about 2 wt. %.

A heteropoly acid refers to polyacids formed by the condensation of different kinds of oxo acids through dehydration and contains a mono- or poly-nuclear complex ion wherein a hetero element is present in the center and the oxo acid residues are condensed through oxygen atoms. Such a heteropoly acid is represented by the formula:

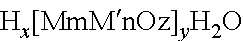

wherein
M represents an element selected from the group consisting of P, Si, Ge, Sn, As, Sb, U, Mn, Re, Cu, Ni, Ti, Co, Fe, Cr, Th or Ce,
M′ represents an element selected from the group consisting of W, Mo, V or Nb,
m is 1 to 10,
n is 6 to 40,
z is 10 to 100,
x is an integer of 1 or above, and
y is 0 to 50.

The central element (M) in the formula described above may be composed of one or more kinds of elements selected from P and Si and the coordinate element (M′) is composed of at least one element selected from W, Mo and V, particularly W or Mo.

Specific examples of heteropoly acids are phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstovanadic acid and acid salts thereof. Excellent results have been achieved with heteropoly acids selected from 12-molybdophosphoric acid (H₃PMo₁₂O₄₀) and 12-tungstophosphoric acid (H₃PW₁₂O₄₀) and mixtures thereof.

The heteropoly acid may be dissolved in an alkyl ester of a polybasic carboxylic acid. It has been found that alkyl esters of polybasic carboxylic acid are effective to dissolve the heteropoly acids or salts thereof at room temperature (25° C.).

The alkyl ester of the polybasic carboxylic acid can easily be separated from the production stream since no azeotropic mixtures are formed. Additionally, the alkyl ester of the polybasic carboxylic acid used to dissolve the heteropoly acid or an acid salt thereof fulfills the safety aspects and environmental aspects and, moreover, is inert under the conditions for the manufacturing of oxymethylene polymers.

Preferably the alkyl ester of a polybasic carboxylic acid is an alkyl ester of an aliphatic dicarboxylic acid of the formula:

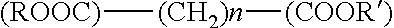

wherein
n is an integer from 2 to 12, preferably 3 to 6 and
R and R′ represent independently from each other an alkyl group having 1 to 4 carbon atoms, preferably selected from the group consisting of methyl, ethyl, n-propyl, iso-propyl, n-butyl, iso-butyl and tert.-butyl.

In one embodiment, the polybasic carboxylic acid comprises the dimethyl or diethyl ester of the above-mentioned formula, such as a dimethyl adipate (DMA).

The alkyl ester of the polybasic carboxylic acid may also be represented by the following formula:

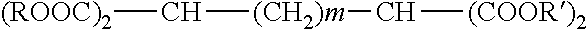

wherein
m is an integer from 0 to 10, preferably from 2 to 4 and
R and R′ are independently from each other alkyl groups having 1 to 4 carbon atoms, preferably selected from the group consisting of methyl, ethyl, n-propyl, iso-propyl, n-butyl, iso-butyl and tert.-butyl.

Particularly preferred components which can be used to dissolve the heteropoly acid according to the above formula are butantetracarboxylic acid tetratethyl ester or butantetracarboxylic acid tetramethyl ester.

Specific examples of the alkyl ester of a polybasic carboxylic acid are dimethyl glutaric acid, dimethyl adipic acid, dimethyl pimelic acid, dimethyl suberic acid, diethyl glutaric acid, diethyl adipic acid, diethyl pimelic acid, diethyl suberic acid, diemethyl phthalic acid, dimethyl isophthalic acid, dimethyl terephthalic acid, diethyl phthalic acid, diethyl isophthalic acid, diethyl terephthalic acid, butantetracarboxylic acid tetramethylester and butantetracarboxylic acid tetraethylester as well as mixtures thereof. Other examples include dimethylisophthalate, diethylisophthalate, dimethylterephthalate or diethylterephthalate.

Preferably, the heteropoly acid is dissolved in the alkyl ester of the polybasic carboxylic acid in an amount lower than 5 wt. %, preferably in an amount ranging from 0.01 to 5 wt. %, wherein the weight is based on the entire solution.

In some embodiments, the polymer composition of the present disclosure may contain other polyoxymethylene homopolymers and/or polyoxymethylene copolymers. Such polymers, for instance, are generally unbranched linear polymers which contain at least 80%, such as at least 90%, oxymethylene units.

The polyoxymethylene polymer can have any suitable molecular weight. The molecular weight of the polymer, for instance, can be from about 4,000 grams per mole to about 20,000 g/mol. In other embodiments, however, the molecular weight can be well above 20,000 g/mol, such as from about 20,000 g/mol to about 100,000 g/mol.

The polyoxymethylene polymer present in the composition can generally melt flow index (MFI) ranging from about 1 to about 50 g/10 min, as determined according to ISO 1133 at 190° C. and 2.16 kg, though polyoxymethylenes having a higher or lower melt flow index are also encompassed herein. For example, the polyoxymethylene polymer may be a low or mid-molecular weight polyoxymethylene that has a melt flow index of greater than about 4 g/10 min, such as greater than about 5 g/10 min, such as greater than about 6 g/10 min, such as greater than about 7 g/10 min, greater than about 10 g/10 min, or greater than about 15 g/10 min. The melt flow index of the polyoxymethylene polymer can be less than about 25 g/10 min, less than about 20 g/10 min, less than about 18 g/10 min, less than about 15 g/10 min, less than about 14 g/10 min.

Suitable commercially available polyoxymethylene polymers are available under the trade name Hostaform® (HF) by Celanese/Ticona.

The polyoxymethylene polymer may be present in the polyoxymethylene polymer composition in an amount of at least 50 wt. %, such as at least 60 wt. %, such as at least 65 wt. %, such as at least 70 wt. %, such as at least 80 wt. %. In general, the polyoxymethylene polymer is present in an amount of less than about 95 wt. %, such as less than about 90 wt. %, wherein the weight is based on the total weight of the polyoxymethylene polymer composition.

In one aspect, the polyoxymethylene polymer as described above can be combined with reinforcing fibers. Reinforcing fibers of which use may advantageously be made are mineral fibers, such as glass fibers, polymer fibers, in particular organic high-modulus fibers, such as aramid fibers, or metal fibers, such as steel fibers, or carbon fibers or natural fibers, fibers from renewable resources.

These fibers may be in modified or unmodified form, e.g. provided with a sizing agent, or chemically treated, in order to improve adhesion to the plastic. Glass fibers are particularly preferred.

Glass fibers are provided with a sizing agent to protect the glass fiber, to smooth the fiber but also to improve the adhesion between the fiber and the matrix material. A sizing agent usually comprises silanes, film forming agents, lubricants, wetting agents, adhesive agents optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes. Sizings based on polyurethanes may be used advantageously.

The reinforcing fibers may be compounded into the polyoxymethylene matrix, for example in an extruder or kneader. However, the reinforcing fibers may also advantageously take the form of continuous-filament fibers sheathed or impregnated with the polyoxymethylene molding composition in a process suitable for this purpose, and then processed or wound up in the form of a continuous strand or cut to a desired pellet length so that the fiber lengths and pellet lengths are identical. An example of a process particularly suitable for this purpose is the pultrusion process.

The long-fiber-reinforced polyoxymethylene molding composition may be a glass-fiber bundle which has been sheathed with one or more layers of the polyoxymethylene matrix polymer in such a way that the fibers have not been impregnated and mixing of the fibers and the polyacetal matrix polymer does not take place until processing occurs, for example injection molding. However, the fibers have advantageously been impregnated with the polyacetal matrix polymer.

According to a preferred embodiment, the molding composition of the present invention comprises at least one reinforcing fiber which is a mineral fiber, preferably a glass fiber, more preferably a coated or impregnated glass fiber. In one embodiment, glass fibers are combined with the polyoxymethylene polymer that contain a sizing agent in an amount of from about 0.5% to about 4% by weight.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 15 μm. When present, the respective composition may contain reinforcing fibers in an amount of at least 1 wt. %, such as at least 5 wt. %, such as at least 7 wt. %, such as at least 10 wt. %, such as at least 15 wt. %, such as at least 20 wt. %, such as at least 23 wt. %, and generally less than about 50 wt. %, such as less than about 45 wt. %, such as less than about 40 wt. %, such as less than about 30 wt. %, wherein the weight is based on the total weight of the respective polyoxymethylene polymer composition.

Optionally, the polymer composition can also contain a coupling agent, especially when the polyoxymethylene polymer contains relatively high amounts of reactive functional groups, such as hydroxyl groups, and the glass fibers contain a reactive sizing agent. Coupling agents used include polyfunctional coupling agents, such as trifunctional or bifunctional agents. A suitable coupling agent is a polyisocyanate such as a diisocyanate. The coupling agent may provide a linkage between the polyoxymethylene polymer and the reinforcing fiber and/or sizing material coated on the reinforcing fiber. Generally, the coupling agent is present in an amount of at least about 0.1 wt. %, such as at least about 0.2 wt. % such as at least about 0.3 wt. % and less than about 5 wt. %, such as less than about 3 wt. %, such as less than about 1.5 wt. %. Alternatively, the composition may also be substantially free of any coupling agents such as less than about 0.2 wt. %, such as less than about 0.1 wt. %, such as less than about 0.05 wt. %, such as less than about 0.01 wt. %, such as about 0 wt. %.

A suitable coupling agent is a polyisocyanate, preferably organic diisocyanate, more preferably a polyisocyanate selected from the group consisting of aliphatic diisocyanates, cycloaliphatic diisocyanates, aromatic diisocyanates and mixtures thereof.

Preferred are polyfunctional coupling agents, such as trifunctional or bifunctional agents.

Preferably, the polyisocyanate is a diisocyanate or a triisocyanate which is more preferably selected from 2,2′-, 2,4′-, and 4,4′-diphenylmethane diisocyanate (MDI); 3,3′-dimethyl-4,4′-biphenylene diisocyanate (TODI); toluene diisocyanate (TDI); polymeric MDI; carbodiimide-modified liquid 4,4′-diphenylmethane diisocyanate; para-phenylene diisocyanate (PPDI); meta-phenylene diisocyanate (MPDI); triphenyl methane-4,4′- and triphenyl methane-4,4″-triisocyanate; naphthylene-1,5-diisocyanate; 2,4′-, 4,4′-, and 2,2-biphenyl diisocyanate; polyphenylene polymethylene polyisocyanate (PMDI) (also known as polymeric PMDI); mixtures of MDI and PMDI; mixtures of PMDI and TDI; ethylene diisocyanate; propylene-1,2-diisocyanate; trimethylene diisocyanate; butylenes diisocyanate; bitolylene diisocyanate; tolidine diisocyanate; tetramethylene-1,2-diisocyanate; tetramethylene-1,3-diisocyanate; tetramethylene-1,4-diisocyanate; pentamethylene diisocyanate; 1,6-hexamethylene diisocyanate (HDI); octamethylene diisocyanate; decamethylene diisocyanate; 2,2,4-trimethylhexamethylene diisocyanate; 2,4,4-trimethylhexamethylene diisocyanate; dodecane-1,12-diisocyanate; dicyclohexylmethane diisocyanate; cyclobutane-1,3-diisocyanate; cyclohexane-1,2-diisocyanate; cyclohexane-1,3-diisocyanate; cyclohexane-1,4-diisocyanate; diethylidene diisocyanate; methylcyclohexylene diisocyanate (HTDI); 2,4-methylcyclohexane diisocyanate; 2,6-methylcyclohexane diisocyanate; 4,4′-dicyclohexyl diisocyanate; 2,4′-dicyclohexyl diisocyanate; 1,3,5-cyclohexane triisocyanate; isocyanatomethylcyclohexane isocyanate; 1-isocyanato-3,3,5-trimethyl-5-isocyanatomethylcyclohexane; isocyanatoethylcyclohexane isocyanate; bis(isocyanatomethyl)-cyclohexane diisocyanate; 4,4′-bis(isocyanatomethyl) dicyclohexane; 2,4′-bis(isocyanatomethyl) dicyclohexane; isophorone diisocyanate (IPDI); dimeryl diisocyanate, dodecane-1,12-diisocyanate, 1,10-decamethylene diisocyanate, cyclohexylene-1,2-diisocyanate, 1,10-decamethylene diisocyanate, 1-chlorobenzene-2,4-diisocyanate, furfurylidene diisocyanate, 2,4,4-trimethyl hexamethylene diisocyanate, 2,2,4-trimethyl hexamethylene diisocyanate, dodecamethylene diisocyanate, 1,3-cyclopentane diisocyanate, 1,3-cyclohexane diisocyanate, 1,3-cyclobutane diisocyanate, 1,4-cyclohexane diisocyanate, 4,4′-methylenebis(cyclohexyl isocyanate), 4,4′-methylenebis(phenyl isocyanate), 1-methyl-2,4-cyclohexane diisocyanate, 1-methyl-2,6-cyclohexane diisocyanate, 1,3-bis (isocyanato-methyl)cyclohexane, 1,6-diisocyanato-2,2,4,4-tetra-methylhexane, 1,6-diisocyanato-2,4,4-tetra-trimethylhexane, trans-cyclohexane-1,4-diisocyanate, 3-isocyanato-methyl-3,5,5-trimethylcyclo-hexyl isocyanate, 1-isocyanato-3,3,5-trimethyl-5-isocyanatomethylcyclohexane, cyclo-hexyl isocyanate, dicyclohexylmethane 4,4′-diisocyanate, 1,4-bis(isocyanatomethyl)cyclohexane, m-phenylene diisocyanate, m-xylylene diisocyanate, m-tetramethylxylylene diisocyanate, p-phenylene diisocyanate, p,p′-biphenyl diisocyanate, 3,3′-dimethyl-4,4′-biphenylene diisocyanate, 3,3′-dimethoxy-4,4′-biphenylene diisocyanate, 3,3′-diphenyl-4,4′-biphenylene diisocyanate, 4,4′-biphenylene diisocyanate, 3,3′-dichloro-4,4′-biphenylene diisocyanate, 1,5-naphthalene diisocyanate, 4-chloro-1,3-phenylene diisocyanate, 1,5-tetrahydronaphthalene diisocyanate, metaxylene diisocyanate, 2,4-toluene diisocyanate, 2,4′-diphenylmethane diisocyanate, 2,4-chlorophenylene diisocyanate, 4,4′-diphenylmethane diisocyanate, p,p′-diphenylmethane diisocyanate, 2,4-tolylene diisocyanate, 2,6-tolylene diisocyanate, 2,2-diphenylpropane-4,4′-diisocyanate, 4,4′-toluidine diisocyanate, dianidine diisocyanate, 4,4′-diphenyl ether diisocyanate, 1,3-xylylene diisocyanate, 1,4-naphthylene diisocyanate, azobenzene-4,4′-diisocyanate, diphenyl sulfone-4,4′-diisocyanate, or mixtures thereof.

Especially preferred are aromatic polyisocyanates, such as 4,4′-diphenylmethane diisocyanate (MDI).

In one embodiment, a formaldehyde scavenger, such as a nitrogen-containing compound, may be present. It was discovered that one or more formaldehyde scavengers can further improve the dimensional stability of molded parts made from the polymer composition when contacted with coolant fluids. Mainly, of these are heterocyclic compounds having at least one nitrogen atom as hetero atom which is either adjacent to an amino-substituted carbon atom or to a carbonyl group, for example pyridine, pyrimidine, pyrazine, pyrrolidone, aminopyridine and compounds derived therefrom. Other particularly advantageous compounds are 1,3,5-triazine-2,4,6-triamine (melamine) and its derivatives, such as melamine-formaldehyde condensates and methylol melamine including melamine cyanurate. Oligomeric polyamides are also suitable in principle for use as formaldehyde scavengers. The formaldehyde scavenger may be used individually or in combination.

Further, the formaldehyde scavenger may be a guanamine compound which may include an aliphatic guanamine-based compound, an alicyclic guanamine-based compound, an aromatic guanamine-based compound, a hetero atom-containing guanamine-based compound, or the like. The formaldehyde scavenger may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

The polymer composition of the present disclosure may also contain other known additives such as, for example, antioxidants, acid scavengers, UV stabilizers or heat stabilizers. In addition, the compositions can contain processing auxiliaries, for example adhesion promoters, lubricants, nucleating agents, demolding agents, fillers, or antistatic agents and additives which impart a desired property to the compositions and articles or parts produced therefrom.

In one embodiment, an ultraviolet light stabilizer may be present. The ultraviolet light stabilizer may comprise a benzophenone, a benzotriazole, or a benzoate. The UV light absorber, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, an acid scavenger may be present. The acid scavenger may comprise, for instance, an alkaline earth metal salt. For instance, the acid scavenger may comprise a calcium salt, such as a calcium citrate. The acid scavenger may be present in an amount of at least about 0.001 wt. %, such as at least about 0.005 wt. %, such as at least about 0.0075 wt. % and less than about 1 wt. %, such as less than about 0.75 wt. %, such as less than about 0.5 wt. %, wherein the weight is based on the total weight of the respective polymer composition.

In one embodiment, a nucleant or nucleating agent may be present. The nucleant may increase crystallinity and may comprise an oxymethylene terpolymer. In one particular embodiment, for instance, the nucleant may comprise a terpolymer of butanediol diglycidyl ether, ethylene oxide, and trioxane. The nucleant may be present in the composition in an amount of at least about 0.01 wt. %, such as at least about 0.05 wt. %, such as at least about 0.1 wt. % and less than about 2 wt. %, such as less than about 1.5 wt. %, such as less than about 1 wt. %, wherein the weight is based on the total weight of the respective polymer composition.

In one embodiment, an antioxidant, such as a sterically hindered phenol, may be present. Examples which are available commercially, are pentaerythrityl tetrakis[3-(3,5-di-tert-butyl-4-hydroxyphenyl)propionate], triethylene glycol bis[3-(3-tert-butyl-4-hydroxy-5-methylphenyl)propionate], 3,3′-bis[3-(3,5-di-tert-butyl-4-hydroxyphenyl)propionohydrazide], and hexamethylene glycol bis[3-(3,5-di-tert-butyl-4-hydroxyphenyl)propionate]. The antioxidant may be present in the polymer composition in an amount of at least about 0.01 wt. %, such as at least about 0.05 wt. %, such as at least about 0.075 wt. %, such as at least about 0.1 wt. %, such as at least about 0.15 wt. %, such as at least about 0.2 wt. %, such as at least about 0.25 wt. %, and less than about 1 wt. %, such as less than about 0.75 wt. %, such as less than about 0.5 wt. %, wherein the weight is based on the total weight of the respective polymer composition.

In one embodiment, lights stabilizers, such as sterically hindered amines, may be present in addition to the ultraviolet light stabilizer. Hindered amine light stabilizers that may be used include oligomeric hindered amine compounds that are N-methylated. For instance, hindered amine light stabilizer may comprise a high molecular weight hindered amine stabilizer. The light stabilizers, when present, may be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, lubricants may be present. The lubricant may comprise a polymer wax composition. Further, in one embodiment, a polyethylene glycol polymer (processing aid) may be present in the composition. The polyethylene glycol, for instance, may have a molecular weight of from about 1000 to about 5000, such as from about 3000 to about 4000. In one embodiment, for instance, PEG-75 may be present. In another embodiment, a fatty acid amide such as ethylene bis(stearamide) may be present. Lubricants may generally be present in the polymer composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a compatibilizer, such as a phenoxy resin, may be present. Generally, the phenoxy resin may be present in the composition in an amount of at least about 0.01 wt. %, such as at least about 0.05 wt. %, such as at least about 0.075 wt. % and less than about 1 wt. %, such as less than about 0.75 wt. %, such as less than about 0.5 wt. %, wherein the weight is based on the total weight of the respective polymer composition.

In one embodiment, a colorant may be present. Colorants that may be used include any desired inorganic pigments, such as titanium dioxide, ultramarine blue, cobalt blue, and other organic pigments and dyes, such as phthalocyanines, anthraquinnones, and the like. Other colorants include carbon black or various other polymer-soluble dyes. The colorant may be present in the composition in an amount of at least about 0.01 wt. %, such as at least about 0.05 wt. %, such as at least about 0.1 wt. % and less than about 5 wt. %, such as less than about 2.5 wt. %, such as less than about 1 wt. %, wherein the weight is based on the total weight of the respective polymer composition.

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 100 to 280° C., such as from 120 to 260° C., such as from 140 to 240° C. or 180 to 220° C.

After extrusion, the compositions may be formed into pellets. The pellets can be molded into polymer articles by techniques known in the art such as injection molding, thermoforming, blow molding, rotational molding and the like. According to the present disclosure, the polymer articles demonstrate excellent mechanical properties. In addition, polymer articles made according to the present disclosure exhibit excellent dimensional stability when in constant contact with coolant fluids at elevated temperatures.

While the polyoxymethylene polymer composition and polymer articles produced therefrom of the present invention provide improved tribological properties, the compositions and articles may also exhibit excellent mechanical properties. For example, when tested according to ISO Test No. 527, the polymer composition may have a tensile modulus of greater than about 5,000 MPa, such as greater than about 5,500 MPa, such as greater than about 6,000 MPa. The tensile modulus is generally less than about 10,000 MPa. In one embodiment, the strength at break can be greater than about 100 MPa, such as greater than about 110 MPa. In one embodiment, the strength at break can be from about 130 MPa to about 170 MPa. The strain at break is generally greater than about 2%, such as greater than about 2.5%. The strain at break is generally less than about 5%.

The polymer composition can exhibit a notched Charpy impact strength at 23° C. of greater than about 5 kJ/m², such as greater than about 6 kJ/m², such as greater than about 9 kJ/m². The notched Charpy impact strength is generally less than about 20 kJ/m².

The polymer composition can also exhibit a heat distortion temperature of greater than about 150° C., such as greater than about 155° C., such as greater than about 160° C. In one embodiment, the heat distortion temperature can be from about 155° C. to about 165° C. The heat distortion temperature can be measured at 1.8 MPa according to ISO Test 72-2.

The present disclosure may be better understood with reference to the following examples.

### EXAMPLE

Various polymer compositions were formulated in accordance with the present disclosure and tested for heat aging properties after being immersed in a coolant fluid.

The following polymer compositions were formulated to produce test specimens:

### Formulation No. 1:

70% by weight polyoxymethylene copolymer having a melt flow index of about 13 g/cm³ (melt index measured at 190° C. and at a load 2.16 kg according to ISO Test 1133);
3.19% by weight polyoxymethylene copolymer having a melt index of about 9 g/cm³;
0.5% by weight terpolymer nucleating agent;
0.2% by weight tetrakis[methylene-3-(3,5-di-tert-butyl-4-hydroxyphenyl-propionate)]methane antioxidant;
0.11% by weight 1,3,5-triazine-2,4,6-triamine; and
26% by weight glass fiber

### Formulation No. 2:

70% by weight polyoxymethylene copolymer containing at least 20 mmol/kg hydroxyl end groups and having a melt flow rate of about 9 g/cm³;
3.49% by weight polyoxymethylene copolymer having a melt index of about 9 g/cm³;
0.5% by weight terpolymer nucleating agent;
0.4% by weight tetrakis[methylene-3-(3,5-di-tert-butyl-4-hydroxyphenyl-propionate)]methane antioxidant;
0.11% by weight 1,3,5-triazine-2,4,6-triamine;
25% by weight glass fiber; and
0.5% by weight methylene diphenyl isocyanate coupling agent

### Formulation No. 3:

99.2% by weight polyoxymethylene copolymer having a melt flow index of about 9 g/cm³;
0.25% by weight terpolymer nucleating agent; and
0.25% by weight tetrakis[methylene-3-(3,5-di-tert-butyl-4-hydroxyphenyl-propionate)]methane antioxidant
0.2% N,N′ ethylenedistearamide
0.05% tricalcium citrate
0.05% copolyamide

The components of each respective composition were mixed together and compounded using a ZSK 25MC (Werner & Pfleiderer, Germany) twin screw extruder (zone temperature 190° C., melt temperature about 210° C.). The screw configuration with kneading elements was chosen so that effective thorough mixing of the components took place. The compositions were extruded and pelletized. The pellets were dried for 8 hours at 120° C. and then injection molded.

The polymer compositions were then molded into test specimens and tested for various physical properties initially and after being immersed in a coolant fluid at 108° C. The coolant fluid contained 50% by weight GLYSANTIN G40 commercially available from BASF and 50% by weight water. The total exposure time for the test was 1,008 hours.

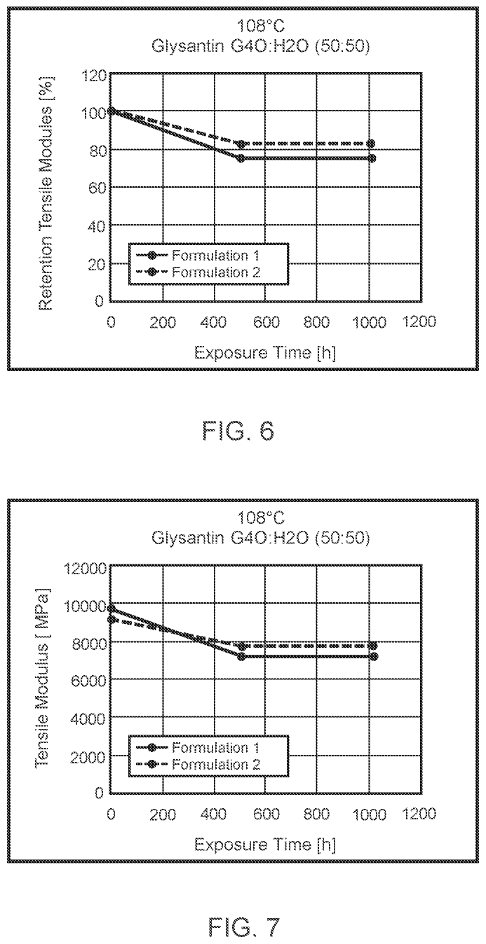

Referring to FIGS. 6 and 7, the results of a coolant fluid tensile modulus change test are illustrated. As shown, Formulation No. 1 and Formulation No. 2 initially displayed a tensile modulus of greater than about 8,000 MPa, such as greater than about 9,000 MPa. After heat aging, the tensile modulus reduced by no more than about 40%, such as by no more than about 30%, such as by no more than about 20% for Formulation No. 2.

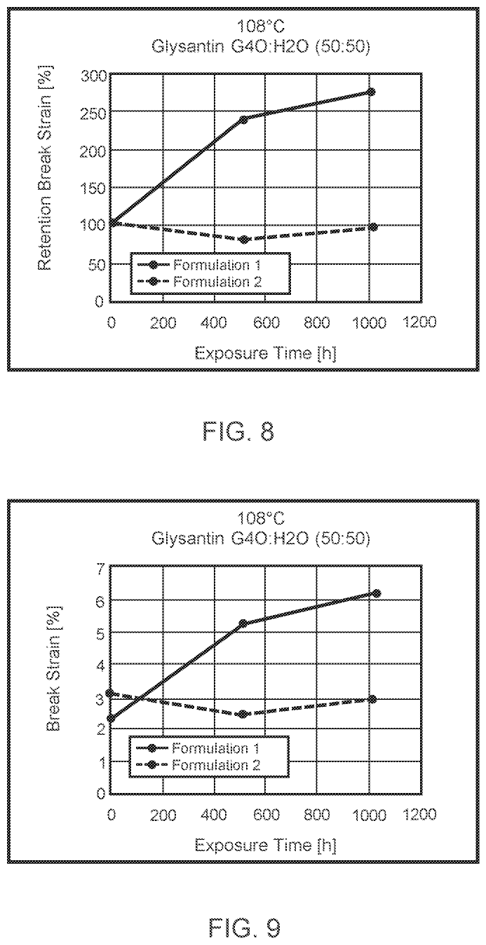

Referring to FIGS. 8 and 9, the results of a coolant fluid break strain test are illustrated. As shown in FIG. 9, the initial break strain of Formulation No. 1 and Formulation No. 2 were above 2%. The break strain of Formulation No. 1 actually increased over time and after exposure to the coolant fluid. As shown in FIG. 8, break strain decreased by no more than about 10%, such as by no more than about 5% after 1,008 hours of exposure time.

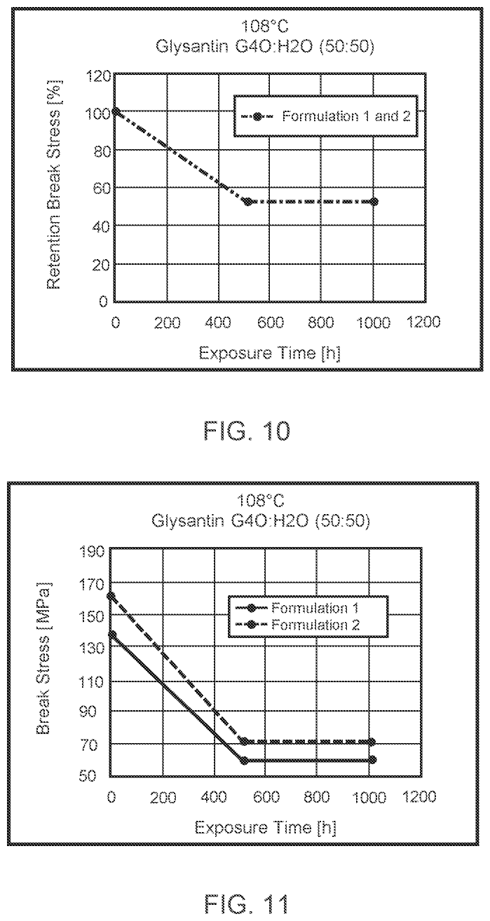

FIGS. 10 and 11 illustrate the results of a coolant fluid break stress change test. As shown, the polymer compositions exhibited an initial break stress of greater than about 120 MPa, such as greater than about 130 MPa. Formulation No. 2 displayed an initial break stress of greater than about 150 MPa, such as greater than about 160 MPa.

After heat aging in the coolant fluid, the break stress reduced by no more than about 60%.

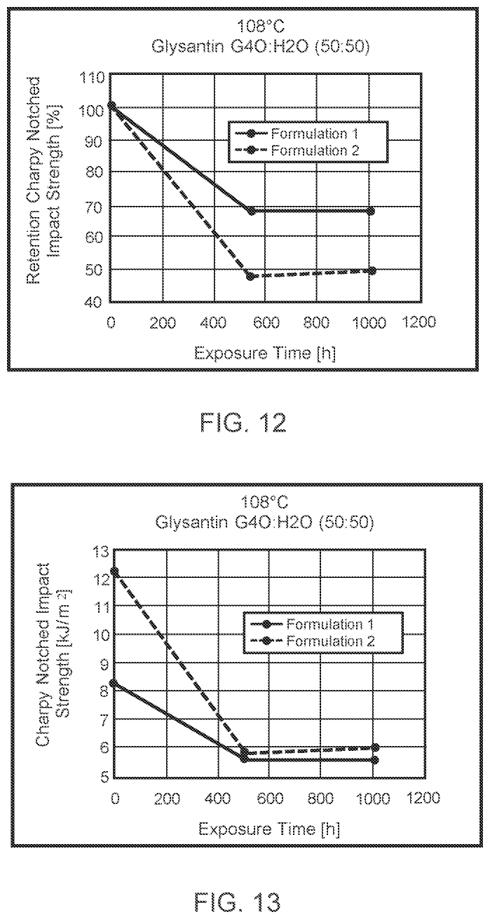

Referring to FIGS. 12 and 13, the results of a coolant fluid Charpy notched impact strength change test are illustrated. As shown in FIG. 13, the polymer compositions exhibited an initial Charpy notched impact strength of greater than about 8 kJ/m², such as greater than about 9 kJ/m², such as greater than about 10 kJ/m², such as greater than about 11 kJ/m², such as greater than about 12 kJ/m². The notched impact strength decreased by no more than about 60% after heat aging in the coolant fluid. Formulation No. 1 decreased by no more than about 40%, such as by no more than about 35% after heat aging.

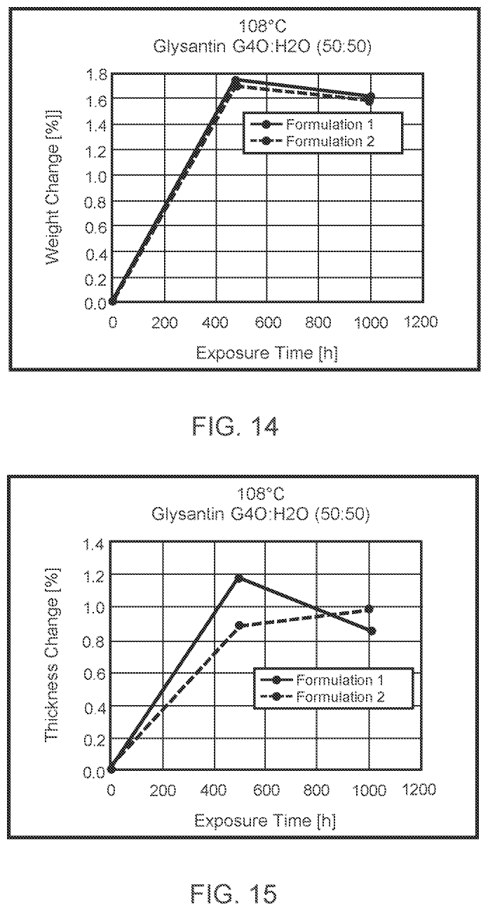

Referring to FIGS. 14 and 15, the results of a coolant fluid weight change test and a coolant fluid thickness change test are illustrated. The thickness change was measured at one end of the test specimen at the widest portion. FIGS. 14 and 15 are the results of testing Formulation No. 1 and Formulation No. 2. As shown, the weight changed by less than about 4%, such as less than about 3%, such as less than about 2.5%, such as less than about 2%, such as less than about 1.8% after heat aging in the coolant fluid. As shown in FIG. 15, the thickness changed by less than about 3%, such as by less than about 2%, such as by less than about 1.5%, such as by less than about 1.2% after heat aging.

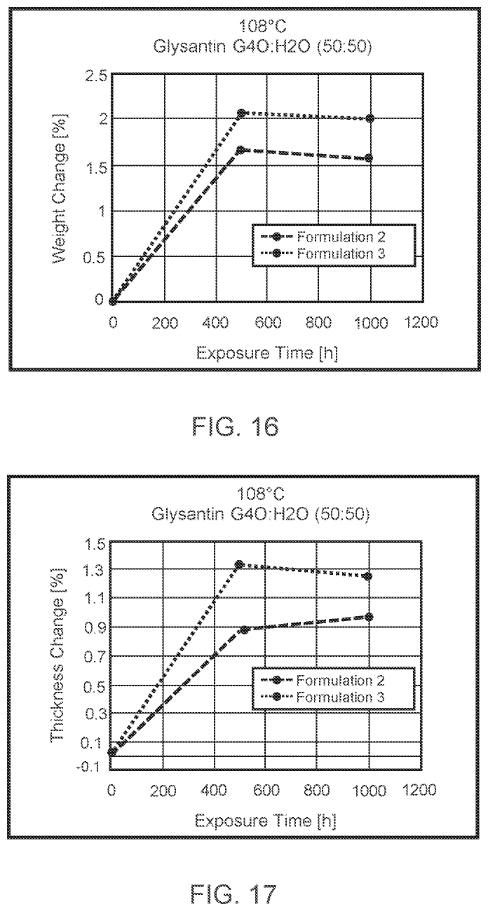

FIGS. 16 and 17 illustrate the results of a coolant fluid weight change test and a coolant fluid thickness change test for Formulation No. 2 and Formulation No. 3. As shown, Formulation No. 3 which did not contain reinforcing fibers showed less dimensional stability and a greater change in weight and thickness.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part.

Furthermore, those of ordinary skill in the art will appreciate that the foregoing description is by way of example only and is not intended to limit the invention so further described in such appended claims.

What is claimed:

1. A polymer article comprising:
a molded polymer component defining at least a portion of a fluid flow path, the molded polymer component being configured to be a portion of a coolant circuit for circulating a coolant fluid comprising a glycol; and
wherein the molded polymer component is formed from a polymer composition comprising a polyoxymethylene polymer blended with reinforcing fibers, the reinforcing fibers being present in the polymer composition in an amount from about 5% by weight to about 55% by weight.

2. A polymer article as defined in claim 1, wherein the molded polymer component comprises a distribution manifold, a valve component, a pump component, a radiation expansion tank, or a tube.

3. A polymer article as defined in claim 1, wherein the molded polymer component comprises a housing defining at least one coolant fluid pathway.

4. A polymer article as defined in claim 1, wherein the polymer composition further contains a formaldehyde scavenger, the formaldehyde scavenger comprising a nitrogen-containing compound.

5. A polymer article as defined in claim 4, wherein the formaldehyde scavenger comprises 1,3,5-triazine-2,4,6-triamine or a derivative thereof.

6. A polymer article as defined in claim 4, wherein the formaldehyde scavenger is present in the polymer composition in an amount from about 0.01% by weight to about 1% by weight.

7. A polymer article as defined in claim 1, wherein the polyoxymethylene polymer includes reactive groups at terminal positions on the polymer and the composition further comprises a coupling agent that couples the polyoxymethylene polymer to the reinforcing fibers.

8. A polymer article as defined in claim 1, wherein the polymer composition has a melt volume flow rate of from about 4 cm³/10 min to about 25 cm³/10 min when measured at 190° C. and at a load of 2.16 kg.

9. A polymer article as defined in claim 7, wherein the reactive groups on the polyoxymethylene polymer comprise hydroxyl groups.

10. A polymer article as defined in claim 9, wherein at least 50% of all terminal groups present on the polyoxymethylene polymer comprise hydroxyl groups.

11. A polymer article as defined in claim 9, wherein hydroxyl groups are present on the polyoxymethylene polymer in an amount from about 15 mmol/kg to about 100 mmol/kg.

12. A polymer article as defined in claim 1, wherein the polyoxymethylene polymer has a melt volume flow rate of from 6 cm³/10 min. to about 15 cm³/10 min.

13. A polymer article as defined in claim 7, wherein the polyoxymethylene polymer is present in the composition in an amount from about 50% to about 90% by weight, the reinforcing fibers comprising glass fibers and being present in the polymer composition in an amount from about 5% to about 30% by weight, and the coupling agent being present in the polymer composition in an amount from about 0.1% to about 3% by weight.

14. A polymer article as defined in claim 7, wherein the coupling agent comprises an isocyanate, such as an organic diisocyanate.

15. A polymer article as defined in claim 7, wherein the coupling agent is present in the composition in an amount from about 0.2% to about 1.5% by weight.

16. A polymer article as defined in claim 7, wherein the reinforcing fibers are coated with a sizing agent, the coupling agent coupling the reactive groups on the polyoxymethylene polymer to the sizing agent.

17. A polymer article as defined in claim 1, wherein the polymer composition displays a weight change of less than about 4% when subjected to a coolant fluid weight change test for 1008 hours at 108 degrees C.

18. A polymer article as defined in claim 1, wherein the polymer composition displays a thickness change of less than about 3% when subjected to a coolant fluid thickness change test for 1008 hours at 108 degrees C.

19. A polymer article as defined in claim 1, wherein the polymer composition displays a break stress decrease of no more than about 60% when subjected to a coolant fluid break stress change test for 1008 hours at 108 degrees C.

20. A polymer article as defined in claim 1, wherein when the polymer composition displays a tensile modulus decrease of no more than about 60%, when subjected to a coolant fluid tensile modulus change test for 1008 hours at 108 degrees C.

21. A polymer article as defined in claim 1, wherein when the polymer composition displays a Charpy notched impact strength decrease of no more than about 50% when subjected to a coolant fluid Charpy notched impact strength change test for 1008 hours at 108 degrees C.
